(19) United States
(12) Patent Application Publication
(10) Pub. No.: US 2006/0183516 A1
(43) Pub. Date: Aug. 17, 2006

(54) Light therapy element incorporated mobile communication device

(76) Inventor: Byung Il Ham, Rancho Pales Verdes, CA (US)

Correspondence Address: Walter T. Kim, Suite 1300, 2030 Main Street, Irvine, CA, 92614, US

(21) Appl. No.: 11/060,261

(22) Filed: Feb. 16, 2005

(51) Int. Cl. H04M 1/00

(52) U.S. Cl. 455/575.3

(57) ABSTRACT

A cellular phone is provided for enable a user of the phone to conduct phototherapy using the phone. The cellular phone includes a body member having a keypad positioned on a first side thereof and a cover member coupled to the body member and movable between a closed position and an open position. The cellular phone further includes a number of light elements coupled to a battery and positioned to deliver light to a skin region of a user of the cellular phone. The delivery of power to the light elements is controlled by a control unit which turns the light elements “on” or “off” based on a user input and the position of the cover member.

### BACKGROUND OF THE INVENTION

1. Field of the Invention

The present invention generally relates to devices and methods for phototherapy, and in particular, to devices and methods for treating skin conditions using light.

2. Description of the Related Art

Various equipments and devices have been devised to treat a variety of skin conditions using light. For example, it has been suggested that phototherapy may be effective as acne treatment. When acne infected skin is exposed to light of certain frequency and/or intensity, acne reduction may be achieved by lowering the number of acne-causing bacteria and promoting tissue healing. Based on clinical studies, it has been observed that acne patients undergoing frequent phototherapy treatments sessions may experience significant acne reduction.

However, there are a number of drawbacks associated with conventional methods of performing phototherapy treatments using large and complex medical equipment. For one thing, many people suffering from acne do not have access to such treatments due to their cost and inconvenience. Further, because acne patients undergoing conventional phototherapy treatments are unable to carry out normal activities during treatment, it may be difficult to administer frequent phototherapy necessary for achieving the desired result. It has been suggested that the effectiveness of phototherapy may depend on factors such as the frequency and duration of the treatment. Accordingly, it is desirable to provide a phototherapy device that is readily available and does not prevent the user from carrying out normal activities during the treatment so that the phototherapy can be repeated as frequently as necessary for achieving the desire result.

### BRIEF SUMMARY OF EMBODIMENTS THE INVENTION

Described herein are various embodiments of a mobile communication device for enabling a user to conduct phototherapy while engaging in conversation using the mobile device. In one embodiment, the mobile device is a cellular phone including a body member having a keypad positioned on a first side of the body member and a cover member movably coupled to the body member. The cover member is movable with respect to the body member between a closed position and an open position. The cellular phone further includes a number of light elements coupled to a battery and positioned on the body member to deliver light to a skin region of a user of the cellular phone. The delivery of power to the light elements is controlled by a control unit which turns the light elements on or off based on a user input and the position of the cover member.

According to an embodiment, the light element incorporated in a cellular phone comprises light emitting diodes (LEDs) which emit light with a wavelength in the range from 370 nanometers to 450 nanometers, and preferably in the range from 400 nanometers to 430 nanometers. The LEDs may be independently switchable with respect to operation of the cellular phone based on the mode of a user operated switch dedicated to the controlling of the power delivered to the LEDs. In one embodiment, each of the LEDs may include a cover having a curved top region. The LEDs may be positioned with respect to at least one of the body member and the cover member such that curved top regions of the LEDs are capable of making contact with skin of the user when the cellular phone is positioned against the body region being treated.

According to an embodiment, the light therapy element incorporated cellular phone may include the functionality to automatically switch from a facial skin illuminating mode in which the light emitted from the LEDs is used to treat the skin of the user to a phone surface illuminating mode when the cover member is moved from the open position to the closed position. When in the phone surface illuminating mode, the LEDs remains turned on for a given period of time while the cover member is in the closed position. The light emitted by the LEDs while the cover member is in the closed position may facilitate destroying at least some of the harmful microorganisms on the surfaces of the phone.

According to an embodiment, a light therapy element incorporated external attachment device is provided, which is configured to removably connect to and receive electrical power from a mobile communication device, such as a cellular phone. In one embodiment, the external attachment device includes a casing having a plurality of light therapy elements disposed thereon and a mechanical connector coupled to the casing to removably attach to a particular type of cellular phone. The external attachment device further includes an electrical connector for coupling to and receiving power from the battery of the cellular phone and a control circuit coupled between the electrical connector and the light elements to control the delivery of power from the battery of the cellular phone to the light elements.

### BRIEF DESCRIPTION OF THE DRAWINGS

Embodiments of the invention are illustrated by way of example and not by way of limitation in the figures of the accompanying drawings in which like references indicate similar elements. It should be noted that the references to “an embodiment” or “one embodiment” of this disclosure are not necessarily to the same embodiment, and such references mean at least one.

FIGS. 1A and 1B show diagrammatic perspective views of a light therapy elements incorporated mobile device according to one embodiment of the present invention.

FIGS. 2A and 2B show diagrammatic perspective views of a light therapy elements incorporated mobile device according to another embodiment of the present invention.

FIG. 3 shows a block diagram of a light therapy elements incorporated mobile device according to an embodiment of the present invention.

FIG. 4 shows a flowchart diagram of a process for operating a light therapy elements incorporated mobile device according to an embodiment of the present invention.

FIG. 5 shows a flowchart diagram of a process for controlling activation and deactivation of light elements provided on a mobile device according to an embodiment of the present invention.

FIGS. 6A, 6B and 6C show side elevational views of light elements incorporated in mobile devices according to various embodiments of the present invention.

### DETAILED DESCRIPTION OF THE INVENTION

In the following description, specific details are set forth in order to provide a thorough understanding of various embodiments of the present invention. However, it will be apparent to one skilled in the art that embodiments of the present invention may be practiced without these specific details. In other instances, well-known hardware and software components, structures and techniques have not been shown in detail in order to avoid obscuring embodiments of the present invention. It should be noted that, as used in the description herein and the claims, the meaning of “in” includes “in” and “on”.

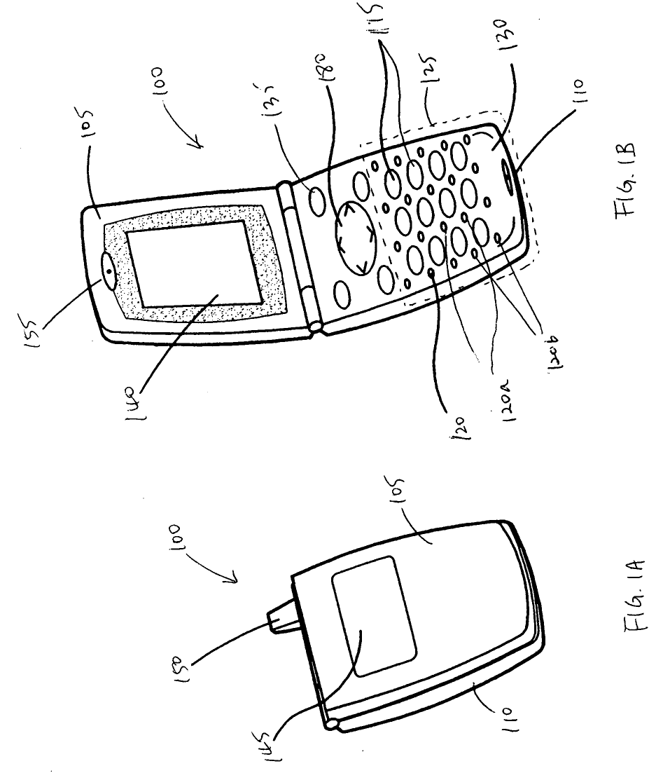

FIGS. 1A and 1B show diagrammatic perspective views of a light therapy elements incorporated mobile device 100 according to one embodiment of the present invention. The mobile device 100 may be a wireless communication device capable of sending and receiving signals over a wireless network. The mobile device can be cellular phones, personal digital assistants (PDAs) and/or other types of mobile devices. In the illustrated embodiment, the mobile device is a flip type cellular phone 100 having a cover member 105 pivotally attached to a body member 110. The cover member 105 is movable between a closed position as shown in FIG. 1A and an open position as shown in FIG. 1B. The body member 110 includes a keypad 125 disposed on a front side portion of the body member 110. The keypad may include a numeric keypad having a number of keys 115 and a scroll or cursor button 180.

Also included in the body member 110 are a number of light elements 120 disposed on the front side portion of the body member such that the light illuminating from the light elements is directed towards a facial region of a cellular phone user when the cover member 105 is in the open position. This allows the user to perform phototherapy while using the phone 100 to conduct conversation over a wireless network. In one embodiment, the light elements 120 are disposed in the keypad region 125 of the cellular phone 100 as shown in FIG. 1B. In this regard, the keypad region 125 of the phone can be positioned within a short distance of the facial area that needs the treatment. In one embodiment, to increase or maximize an amount of facial region covered by the light elements 120, some of the light elements 120a are disposed between the keys 115 and other light elements 120b are disposed in the peripheral region of the keypad region 125.

In one embodiment, the light elements 120 comprise LEDs disposed at least partially within apertures situated in the front side portion 130 of the body member 110. The LEDs 120 are positioned to emit light towards the phone user and away from the body member 110 the cellular phone. As illustrated in FIG. 1B, the LEDs are arranged in an array comprising five rows and four columns. In one embodiment, the front side portion 130 of the body member 110 may be provided with a reflective surface to effectively deliver the light emitted by the LEDs 120 toward the phone user receiving the phototherapy. In one embodiment, one or more optical elements may be coupled to the front side portion 130 of the body member 110 and positioned above the LEDs 120 to concentrate and/or change the angle of light emitted by the LEDs before the light illuminates the skin of the user. In another embodiment, the light is emitted directly from the LEDs 120 onto the skin of the user without use of any optical element.

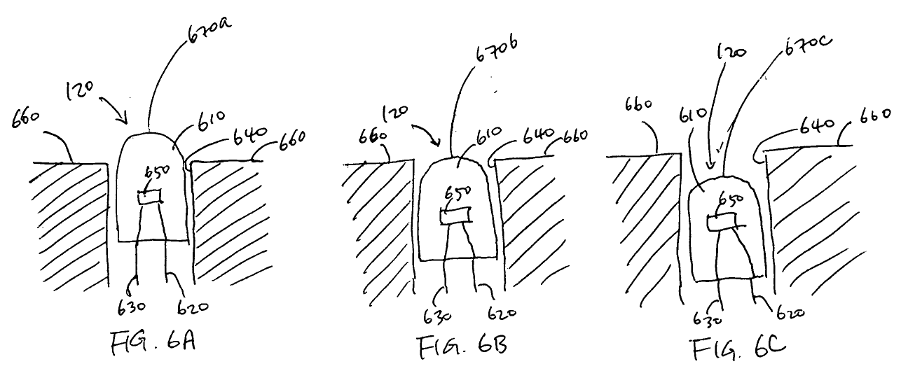

FIGS. 6A, 6B and 6C show side elevational views of LEDs incorporated in cellular phone according to various embodiments of the present invention. Each LED 120 may comprise one or more LED elements 650 disposed within a cover 610 and leads 620, 630 extending from the cover 610 to deliver power to the LED element(s) 650. The cover 610 may be made of a transparent resin and have a curved top functioning as a convex lens. In one embodiment, the LED 120 may be disposed within an aperture 640 provided in the cellular phone 110 such that upper portion 670a of the LED's cover 610 extend slight above the upper front surface 660 of the body member 110, as shown in FIG. 6A. This enables the upper portion 670a of the LED's cover 610 to make contact with the user's facial skin when the body member of the phone is placed against the user's facial skin. In another embodiment, the LED 120 is secured on the cellular phone 110 such that upper edge 670b of the LED's cover 610 is situated approximately level with the upper front surface 660 of the body member 110, as shown in FIG. 6B. In yet another embodiment, the LED 120 is secured on the cellular phone 110 such that the upper edge 670c of the LED's cover 610 is situated slightly below the upper front surface 660 of the body member 110, as shown in FIG. 6C.

The light elements 120 included in the cellular phone 100 may comprise LEDs which emit light with a wavelength in the range from 370 nanometers to 700 nanometers. In one embodiment, the light elements 120 comprise LEDs which emit violet/blue light with a wavelength in the range from 370 nanometers to 450 nanometers, and preferably in the range from 400 nanometers to 430 nanometers. This range may be particularly suitable for treatment of acne or other skin conditions. When acne infected skin is exposed to the light with wavelengths of approximately 370 to 450 nanometers, it has been suggested that the spread of acne may be inhibited by making the skin inhospitable for acne-causing bacteria and reducing pH gradients. The LEDs 120 may be of the type that can emit high intensity light and may be power by low voltage power source, such as batteries included in cellular phones. In another embodiment, the light elements 120 may include LEDs which emit red light with a wavelength in the range from 620 nanometers to 700 nanometers. This range may be suitable for treating various skin conditions by increasing circulation, stimulating the production of collage, and helping to heal wounds and repairing other skin damages.

There are a number of advantages may be achieved by the use of the light therapy element incorporated cellular phone 100 according to various embodiments of the present invention. It has been suggested that the effectiveness of the phototherapy to treat skin conditions, such as acne, depends on several factors, including the frequency of the treatment and the duration of the treatment. In the instant case, because the phototherapy can be performed each time the cellular phone is used, the phone user can perform the treatment as frequently as the phone is used. Accordingly the effective phototherapy can be achieved by treating the acne affected area for time periods (e.g., five to twenty minutes) and repeated as needed to prevent or reduce the spread of acne.

Also included in the cellular phone 100 are a user input device 135 and a display screen 140 coupled to a control unit to enable a user to select different modes of phototherapy operations, including manually turning on/off of the light elements. The user input device 135 may comprise one or more push-button switches, toggle switches and/or the keypad to enable the user to select values of parameters of the treatment, such as the timing and/or intensity of the light energy emitted by the LEDs 120. The display screen 140 may provide indications of different operation modes in terms of the duration of the phototherapy and when the LEDs are scheduled to automatically switch off.

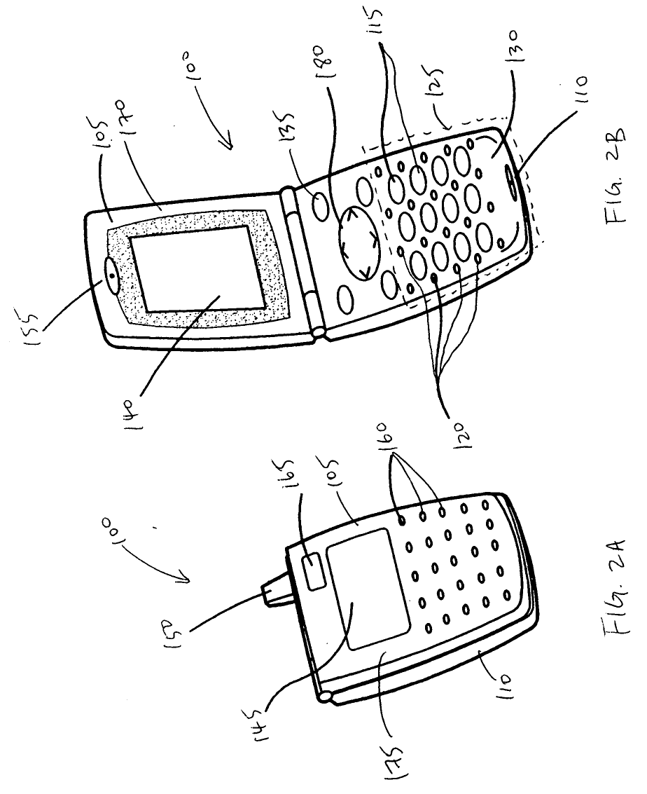

FIGS. 2A and 2B show diagrammatic perspective views of a light therapy elements incorporated cellular phone 100 according to another embodiment of the present invention. In this embodiment, the cellular phone 100 includes at least two arrays of LEDs. A first array of LEDs 120 provided on the front side portion 130 of the body member 110 and a second array of LEDs 160 provided on the front side portion 175 of the cover member 105. As shown in FIGS. 2A and 2B, the cover member 105 includes a back side portion 170 provided with a primary display screen 140 and the front side portion 175 provided with a secondary display screen 145. In the illustrated embodiment, the second array of LEDs 160 is provided on the front side portion 175 of the cover member 105 below the secondary display screen 145. Also included in the cellular phone 100 is a control unit to enable the user to control operation one array of LEDs independent of the other LED array. Accordingly, the second array of LEDs 160 is independently switchable with respect to the first array of LEDs 120. The independently switchable second array of LEDs 160 allows the user to perform phototherapy while the cover member 105 is in the closed position. In one embodiment, the first array of LEDs 120 may emit light in a spectrum which is different from the light emitted by the second array of LEDs 160. In another embodiment, the first array of LEDs 120 emits light in the same spectrum as the light emitted by the second array of LEDs 160.

In one embodiment, at least a portion of the LEDs 120 and the LEDs 160 may be of a type of LED which includes multiple LED elements such that it is capable of emitting light of various wavelengths, such as violet, blue and red by adjusting the emission intensity of each LED element included in the LED cover.

Although mobile devices are described more fully herein in relation to a flip type cellular phone 100 as shown in FIGS. 1 and 2, it should be appreciated that other types of cellular phones or mobile devices are also contemplated by embodiments of the present invention. For example, in one embodiment, the mobile device into which light elements are incorporated may be a sliding type cellular phone having a cover member coupled to a body member such that the cover member is slidable with respect to the body member between a closed position and an open position, in which case, the light element may be disposed on the body member, in and/or adjacent to the keypad region. In another embodiment, the mobile device into which light elements are incorporated may be a bar type cellular phone having a keypad disposed outside on the front side portion of the phone body, in which case, the light elements may be disposed on the front side of the phone, in and/or adjacent to the keypad region.

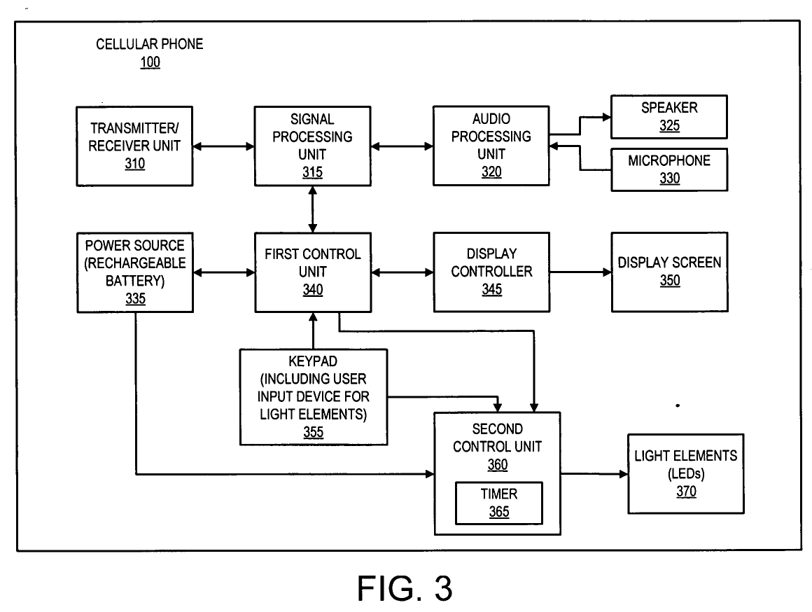

FIG. 3 shows a block diagram of a light therapy elements incorporated cellular phone 100 according to an embodiment of the present invention. The cellular phone 100 includes a transmitter/receiver unit 310 coupled to an antenna for transmitting and receiving communication signals via a wireless communication network. A signal processing unit 315 is coupled between the transmitter/receiver unit 310 and a first control unit 340 to enable communication of signals between the transmitter/receiver unit 310 and the first control unit 340. A keypad 355 is coupled to the first control unit 340 to enable entry of information which can be displayed on a display screen 350 via a display controller 345. The keypad 355 may include a numeric keypad having alphanumeric-entry capability. An audio processing unit 320 is coupled between a microphone 330 and a speaker 325 and the signal processing unit 315.

Also included in the cellular phone 100 is a power source 335, such as a rechargeable battery to supply power to various components within the cellular phone, including the light elements 370. In one embodiment, the battery 335 is coupled to the light elements 370 via a second control unit 360 to control the electrical power supplied to the light elements 370. The second control unit 360 is coupled to a user input device 355 such as buttons, switches, keypad and/or display screen to enable a user to select different modes of phototherapy operations, including manually turning on/off of the light elements 370. The second control unit 360 may further be configured to enable the user to input selected values of parameters of the treatment, such as the timing and intensity of the light energy. The second control unit 360 may include a timer 365 to monitor and control the duration of the treatment or timing of when the light elements are automatically switched off. In one embodiment, the second control unit 360 is configured to automatically turn off the light elements a predetermined time after the cover member is moved from the open position to the closed position.

In one embodiment, the first control unit 340 has the functionality to monitor the available battery power level and send a low battery condition signal to the second control unit 360 when the available battery power level falls below a predetermined threshold. When the low battery condition signal is received, the second control unit may automatically turn off the delivery of electrical power to the light elements and notify the user of the low battery condition via a user notification message on the display screen 350.

While an exemplary cellular phone 100 is described with respect to FIG. 3, other components, functions of cellular phones could be employed which are well known in the art. For example, although the first control unit 340 and the second control unit 360 are shown as separate components, it should be noted that any suitable arrangement of components can be employed to provide the functionalities described herein. More specifically, in one embodiment, the first control unit 340 and the second control unit 360 are integrated into a single controller chip. Further, in various embodiments, hard-wired circuitry may be used in place of or in combination with software instructions to implement the functionalities described herein. Thus, the embodiments of the present invention are not limited to any specific combination of arrangements of hardware circuitry and software components. The cellular phone 100 as shown in FIG. 3 is merely an exemplary device showing the fundamental features of a cellular phone employing the features and functions of embodiments of the present invention.

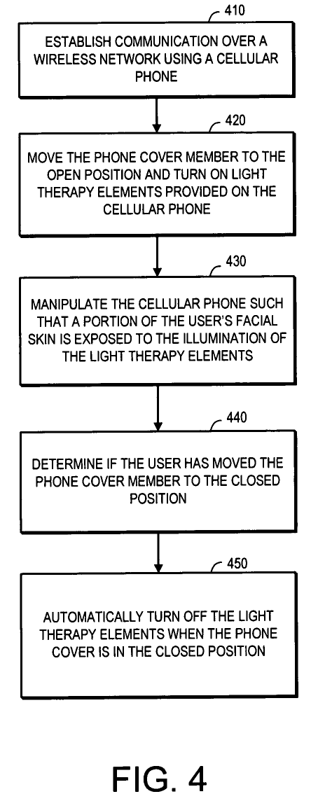

FIG. 4 is a flowchart describing general operations involved in performing phototherapy using a cellular phone according to an embodiment of the present invention. Because the phototherapy is performed using the light therapy elements incorporated cellular phone as described and shown in FIGS. 1-3, the user can advantageously carry out normal activities, such as conducting a conversation over the phone, during the treatment. Accordingly, the user of the cellular phone may establish a communication over a wireless network in block 410. Either prior to or after the establishing of the wireless communication, the user can move the cover member to the open position and turn on the light elements provided on the cellular phone in block 420. Based on the user's input, the control unit controls the deliver of power from the battery of the cellular phone to the light elements. In one embodiment, the control unit is configured to turn on the light elements if the cover member is in the open position and the user has selected the light elements to be powered on. In block 430, the user can perform phototherapy while using the cellular phone to engage in a conversation over the wireless network. The cellular phone can positioned against the user's face such that the LEDs provided on the front side portion of the body member of the phone illuminates a portion of the user's facial skin that needs treatment. The phone may be periodically moved to illuminate a different portion of the user's facial skin as needed. In block 440, the control unit is configured to periodically check to see if the cover member has moved from the open position to the closed position to determine if the light elements need to remain powered on. In block 450, the control unit will automatically turn off the light elements if it detects that the cover member of the cellular phone has moved to the closed position.

While an exemplary use of the cellular phone is described with respect to using the light illuminating from the cellular phone to treat the facial region of the user, it should be noted that the light therapy element incorporated cellular phone may be used to treat any other suitable body region of the user, including but not limited to arm, back, leg, shoulder, hand and chest regions.

It should further be noted that when the user is using the cellular phone to perform phototherapy at home, office or other place where it is possible to plug the cellular phone into an external power source, such as an electrical wall outlet, it may be desirable to use the cellular phone with a power cord connected to the cellular phone and plugged into an external power source (e.g., electrical outlet) so that the phototherapy can be performed while the cellular phone battery is recharging. In this regard, the electrical power from the external power source may be shared to both power the light elements for phototherapy and recharge the depleted battery pack.

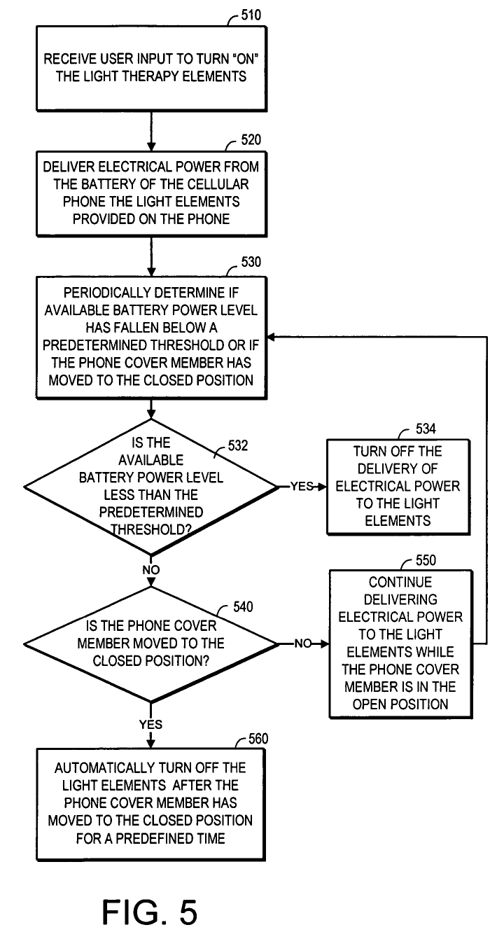

FIG. 5 shows general operations involved in controlling activation and deactivation of light therapy elements provided on a cellular phone according to another embodiment of the present invention. In block 520, the cellular phone receives a user input for turning on the light therapy elements. In one embodiment, if the cover member is in the open position and a user input device (e.g., a toggle switch) on the cellular phone can be used by the user to toggle between “light therapy elements on” and “light therapy elements off.” If the toggle switch is in the “light therapy elements on” mode, the control circuit in the cellular phone will deliver electrical power from the battery of the cellular phone to the light elements in block 520. In block 530, the control unit periodically monitors the available battery power level and will generate a low battery condition signal if the available battery power level falls below a predetermined threshold. In addition, the control unit will periodically monitor the position of the cover member. If the available battery power level is less than the predetermined threshold (block 532, yes), the control unit will automatically cut off the deliver of electrical power to the light elements in block 544 and notify the user of the low battery condition. This enables certain amount of battery power be reserved for operating the cellular phone to conduct a wireless communication. On the other hand, if the available battery power level is greater than the predetermined threshold (block 535, no), the process proceeds to block 540, where it checks the position of the phone cover member. If it is determined that the cover member is remaining in the open position (block 540, no), then the control unit will keep the light elements turned on while the phone cover is in the open position in block 550.

In one embodiment, the control unit may be configured to switch from a facial skin illuminating mode in which the light illuminating from the light elements is used to treat the skin of the user to a phone surface illuminating mode in which the light elements to remain turned on for a defined time after the cover member has been closed. The light emitted by the light elements while the cover member is in the closed position may facilitate destroying at least some of the harmful microorganisms on the surfaces of the phone. In this regard, in one embodiment, the type of light elements and the parameters of the light emitted by the light elements are selected such that when the light elements remain turned on for a defined time while the cover member is maintained in the closed position, the light emitted thereby is capable of destroying or reducing the number of harmful microorganisms on the phone surface such as the keypad region and the display screen region. Referring back to the flowchart, if it is determined that the cover member has moved to the closed position (block 540, yes), the control unit keeps the light elements turned on for the predetermined time and cuts off electrical power to the light elements only after the predetermined time has passed since the cover member has moved to the closed position in block 560. The control unit may be configured to adjust the intensity of the light emitted from the light elements when switching from the facial skin illuminating mode to the phone surface illuminating mode.

In one embodiment, the control unit may be configured to automatically switch from a “light element off” mode to the phone surface illuminating mode when the user closes the cover member of the phone to the closed position when the light elements are powered off. This enables the light elements to be switched on as soon as the cover member is in the closed position and remain turned on for a predetermined time to possibly destroy at least some of the harmful microorganisms on the surface of the phone after each use of the phone.

When the phone is in the phone surface illuminating mode, the control unit may select parameters (e.g., intensity and wavelength) of light emitted by the light elements which are suitable for destroying at least some of the harmful microorganisms that may remain on the phone surface after use. As noted above, the light elements incorporated in the cellular phone may include LEDs, each LED having multiple LED elements and capable of emitting light of various wavelengths, such as violet, blue and red by adjusting the emission intensity of each LED element. Accordingly, the color and intensity of light generated by such LEDs can be controlled by the control unit during the phone surface illuminating mode to more effectively destroy harmful microorganisms on the phone surface.

In an alternative embodiment, light therapy elements (e.g., LEDs) are incorporated into an external attachment device for providing phototherapy. The external attachment device is configured to receive electrical power and/or control signals from a cellular phone. The external attachment device includes a casing having a plurality of light elements provided on the casing to emit light away from the casing. The external attachment device may include a mechanical connector coupled to the casing and configured to suit a particular type of cellular phone to removably and securely attach to the cellular phone. In one embodiment, the mechanical connector is configured to position the casing when it is connected to a cellular phone such that when the phone is used to carry out a conversation, the light emitted from the casing can illuminate a facial region of the user. The external attachment device includes an electrical connector for coupled to and receiving power from the battery of the cellular phone. In one embodiment, the electrical connector comprises one or more pins extending through the mechanical connector to couple with the power and ground lines of the cellular phone to receive power from the cellular phone.

The external attachment device further includes a control circuit coupled between the connector and the light elements to control the delivery of power from the battery of the cellular phone to the light elements. A user control switch and a display are coupled to the control circuit to enable a user to select different modes of operations. The display may provide indication of different operation modes, including the duration of the phototherapy selected by the user. The control circuit may be configured to enable the user to adjust the duration of phototherapy. In this regard, the control circuit may include a timer to automatically turn off the light elements after the duration of time selected by the user. The control circuit may be configured to enable the user to adjust intensity of light emitted by the light elements. In one embodiment, the control circuit contained with the external attachment device is configured to receive control signals from the cellular phone. In one embodiment, the light elements comprise LEDs which emit light with a wavelength in the range from 400 nanometers to 450 nanometers. In one embodiment, LEDs are disposed at least partially within apertures situated in the front side portion of the casing. The LEDs are positioned to emit light towards a facial region of the user of the cellular phone user when the casing is securely attached to the phone.

While the foregoing embodiments of the invention have been described and shown, it is understood that variations and modifications, such as those suggested and others within the spirit and scope of the invention, may occur to those skilled in the art to which the invention pertains. The scope of the present invention accordingly is to be defined as set forth in the appended claims.

What is claimed is:

1. A cellular phone comprising:
a body member having a keypad positioned on a first side portion thereof;
a cover member coupled to the body member, the cover member movable with respect to the body member between a closed position and an open position;
a plurality of light elements coupled to a battery, the light elements positioned to deliver light to a skin region of a user of the cellular phone; and
a control unit coupled between the light elements and the battery to control delivery of electrical power from the battery to the light elements.

2. The cellular phone of claim, wherein the light elements comprise a set of LEDs, each LED including a cover having a curved top region, wherein the LEDs are positioned with respect to at least one of the body member and the cover member such that the curved top regions of the LEDs are capable of making contact with skin of the user.

3. The cellular phone of claim 1, wherein the control unit controls delivery of electrical power to the light elements based on a user input and the position of the cover member.

4. The cellular phone of claim 1, wherein the light elements comprise LEDs which are capable of emitting light with a wavelength in the range from 370 nanometers to 450 nanometers.

5. The cellular phone of claim 1, wherein light illuminating from the light elements is used to provide light therapy to skin of the user.

6. The cellular phone of claim 1, wherein the light elements comprise LEDs, at least a portion of the LEDS is a type of LED which includes multiple LED elements such that the LED is capable of emitting light of various wavelengths by adjusting emission intensity of each LED element.

7. The cellular phone of claim 6, wherein the control unit is configured to enable the user to select color of light emitted from the light elements.

8. The cellular phone of claim 1, wherein the light elements comprise:
a first set of LEDs disposed at least partially within the first side portion of the body member; and
a second set of LEDs disposed at least partially within a first side portion of the cover member, wherein the second set of LEDs is independently switchable with respect to the first set of LEDs.

9. The cellular phone of claim 1, wherein the light elements comprise LEDs which are capable of emitting light with a wavelength in the range from 620 nanometers to 700 nanometers.

10. The cellular phone of claim 1, wherein at least one of the light elements is situated between keys of the keypad.

11. The cellular phone of claim 1, wherein the control unit is configured to enable the user to select an amount of time the light elements are to remain turned on.

12. The cellular phone of claim 1, wherein the control unit is configured to enable the user to select intensity of light emitted from the light elements.

13. A method comprising:
delivering electrical power from a battery to a transmitter/receiver unit to establish a communication over a wireless network;
illuminating light elements using the battery to deliver electrical power to the light elements; and
positioning the light elements such that curved top regions of at least a portion of the light elements establish contact with a skin region of a user to treat the skin region using light emitted from the light elements.

14. The method of claim 13, wherein illumination light elements comprises:
emitting light with a wavelength in the range from 400 nanometers to 450 nanometers from a keypad region of the wireless communication device.

15. The method of claim 14, wherein the light emitted by the light elements is used to treat acne skin condition.

16. The method of claim 13, wherein the light elements are provided on a keypad region of a cellular phone.

17. The method of claim 13, wherein the light elements are coupled to a cellular phone comprising a cover member movably coupled to a body member, the cover member movable with respect to the body member between a closed position and an open position.

18. The method of claim 17, further comprising:
controlling delivery of electrical power from the battery to the light elements based on a user input and the position of the cover member.

19. The method of claim 18, further comprising:
detecting that the cover member has moved from the open position to the closed position;
illuminating the light elements for a predetermined time after the cover member has moved to closed position; and
turning off the light elements after the predetermined time.

20. The method of claim 19, wherein the light elements emit light capable of destroying at least some of microorganisms on a phone surface.

21. The method of claim 13, further comprising:
determining an amount of time the user has selected for the light elements to remain turned on; and
automatically turning off the light elements after expiration of the user selected time.

22. An external attachment device for a cellular phone comprising:
a casing;
a mechanical connector coupled to the casing to removably attach to the cellular phone;
a plurality of light elements coupled to the casing to emit light away from the casing;
an electrical connector to removably couple to receive power from a battery of a cellular phone; and
a control unit coupled between the electrical connector and the light elements to enable a user to control deliver of power from the battery to the light elements.

23. The apparatus of claim 22, wherein the light elements comprise light emitting diodes (LEDs) which emit light with a wavelength in the range from 400 nanometers to 450 nanometers.

24. The apparatus of claim 22, wherein the casing includes a plurality of apertures positioned on a front side portion thereof and the light elements are disposed at least partially within the apertures.

25. The apparatus of claim 24, wherein the electrical connector comprises at least one pin extending through the mechanical connector to couple to the battery of the cellular phone; and
wherein the mechanical connector is configured to position the casing when the mechanical connector is connected to the cellular phone such that when the phone is used to carry out a conversation, the light emitted from the light elements can illuminate a facial region of the user.
